(19) United States
(12) Patent Application Publication
(10) Pub. No.: US 2006/0209211 A1
(43) Pub. Date: Sep. 21, 2006

(54) Mini computer frame having a pivotable plate

(76) Inventor: Chia-Chin Wang, Taipei (TW)

Correspondence Address: HERSHKOVITZ & ASSOCIATES, 1725 I STREET NW, SUITE 300, WASHINGTON, DC, 20006, US

(21) Appl. No.: 11/079,229

(22) Filed: Mar. 15, 2005

(51) Int. Cl. H04N 7/00

(52) U.S. Cl. 348/552

(57) ABSTRACT

A mini computer frame has a base and a plate pivotally connected to the base. The base has a receiving space and the plate has an arcuate surface formed on a rear face of the plate and received in the receiving space. A slot and slits are defined in portions of a bottom face defining the receiving space so that pivotal movement of the plate relative to the base is able to show the slot or the slits.

### BACKGROUND OF THE INVENTION

1. Field of the Invention

The present invention relates to a mini computer frame, and more particularly to a mini computer frame having a pivotable plate.

2. Description of Related Art

The function of a computer frame is meant to provide protection to the elements received inside the frame so that when the fully equipped computer frame is transported, the rigid frame is able to protect the elements from damage. Furthermore, normally a floppy diskette drive, a CD ROM drive, a card reader or the like are mounted on the frame and exposed to the air. However, it is found that the computer frame is not able to protect the electronic elements from damage especially when the computer frame is moved from one place to another. Another drawback to contemporary computer frames is that the space required for installing upgrading components renders the frame excessively large, especially when the trend of most electronic devices is towards compactness. Thus, designers in this field start to consider reductions in computer frame size. Specially, a kind of computer frame having therein only the basic electronic elements without any available room for consideration of upgrading the computer capability becomes mostly welcomed due to its compact configuration. This kind of computer frame is called “a mini computer frame”. This mini computer frame is quite easily exposed to damage in that people tend to be careless with compact objects.

To overcome the shortcomings, the present invention tends to provide an improved computer frame to mitigate the aforementioned problems.

### SUMMARY OF THE INVENTION

The primary objective of the present invention is to provide a mini computer frame having a pivotable plate so that when the plate is not pivoted, electronic elements received in the frame are protected by the plate.

In one aspect of the present invention, the mini computer frame has a receiving space defined in a base. The plate is pivotally connected to the base and has an arcuate rear face and a smooth planar front face. A motor driven gear is received in the receiving space and mated to a rack mounted on the arcuate rear face so that when the gear is rotated due to the motor, the plate is pivoted relative to the base.

In yet another aspect of the present invention, there are two sets of rollers rotatably mounted on a bottom face defining the receiving space to correspond to two recessed tracks defined in the arcuate surface such that when the plate is pivoted, the two sets of rollers are able to maintain the pivotal movement of the plate to be smooth.

A further aspect of the present invention is that the plate has two opposite side faces respectively having a positioning recess defined to correspond to and receive therein a positioning rod formed on a side face defining the receiving space of the-base so that when the plate is pivoted with respect to the base, the slidable movement of the positioning rods inside the corresponding positioning recesses is able to limit the pivotable movement of the plate.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of the mini computer frame of the present invention;

FIG. 2 is an exploded perspective view of the mini computer frame in a different angle relative to that of FIG. 1;

FIG. 3 is a perspective view showing that the plate is still relative to the base; and

FIGS. 4 and 5 are schematic views showing that the plate is pivoted to show slots and slits respectively defined in a top portion and a bottom portion of the bottom face defining the receiving space of the base.

### DETAILED DESCRIPTION OF THE PREFERRED EMBODIMENT

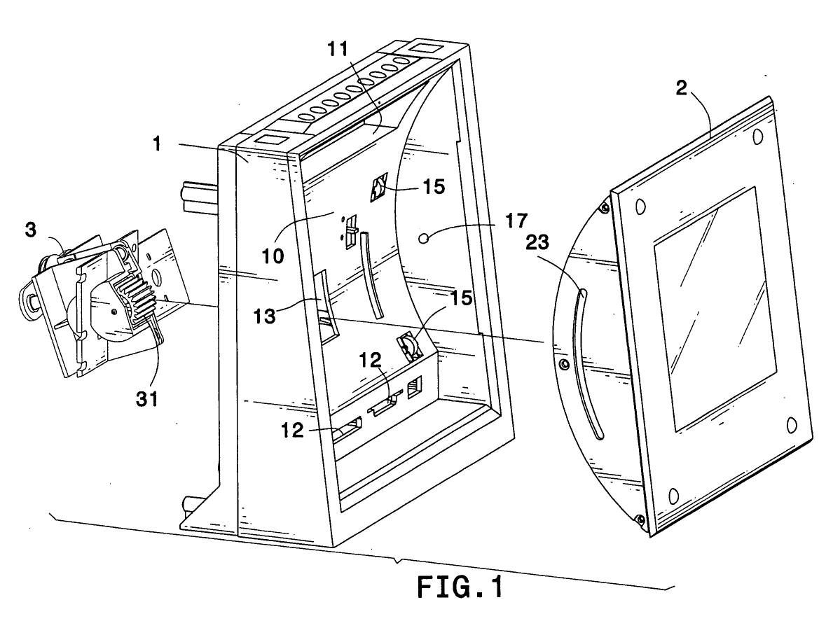

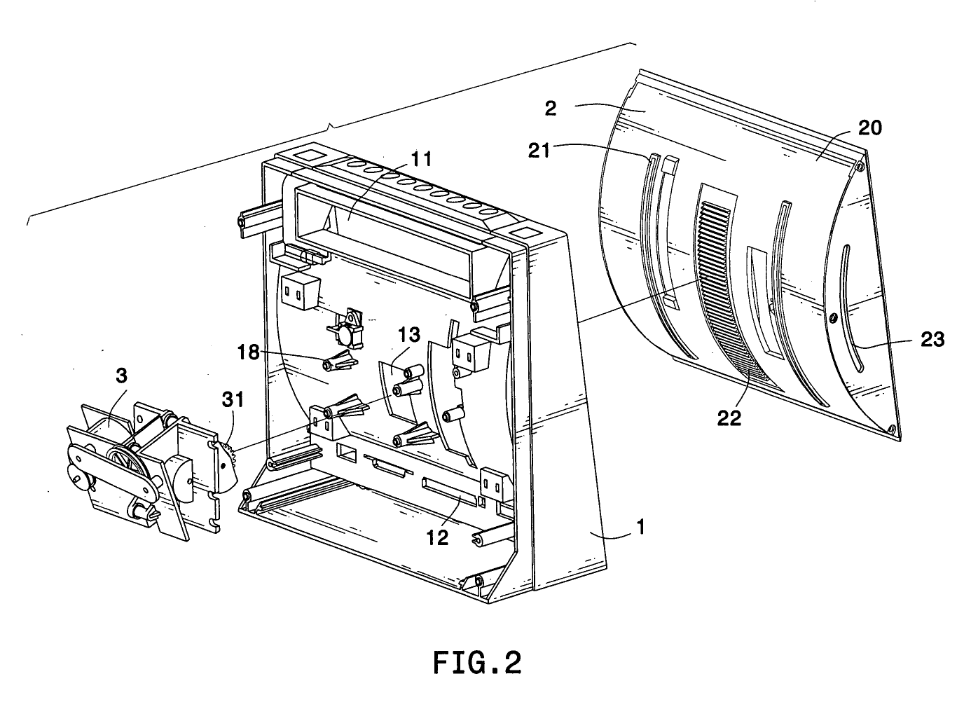

With reference to FIGS. 1 and 2, it is noted that the computer frame in accordance with the present invention includes a base (1) and a plate (2) pivotally connected to the base (1).

The base (1) is defined with a receiving space (10), a slot (11) defined in a top portion of a bottom face defining the receiving space (10), slits (12) defined in a bottom portion of the bottom face defining the receiving space (10), an opening (13) defined in the bottom face of the receiving space (10) and two sets of rollers (15) respectively mounted on the bottom face and spaced apart from each other. Further, two positioning rods (17) are provided respectively on two opposed side faces defining the receiving space (10) and multiple assembly rods (18) are extended from the bottom face of the receiving space (10).

The plate (2) has an arcuate surface (20) formed on a rear face of the plate, two recessed tracks (21) formed on the arcuate surface to correspond to the two sets of rollers (15) of the base (1), a rack (22) formed between the two recessed tracks (21) and two positioning recesses (23) defined respectively in two opposite side faces of the plate (2).

Furthermore, a motor (3) having a gear (31) is provided to the base (1).

When the above mentioned elements are assembled, it is noted that the assembly rods (18) are used to secure the motor (3) and the gear (31) is extended into the receiving space (10) via the opening (13). The two sets of rollers (15) are respectively received in the corresponding recessed tracks (21) after the arcuate surface (20) of the plate (2) is received in the receiving space (10) with the rack (22) mated with the gear (31). The two positioning rods (23) are respectively received in the corresponding positioning recesses (23) of the plate (2) so that when the gear (31) is rotated due to the drive from the motor (3), the plate (2) is pivoted. Further, because of the length limitation of the positioning recesses (23), the sliding movement of the positioning rods (17) inside the positioning recesses (23) is limited and thus pivotal movement of the plate (2) with respect to the base (1) is limited such that excessive pivotal movement of the plate (2) relative to the base (1) is prevented.

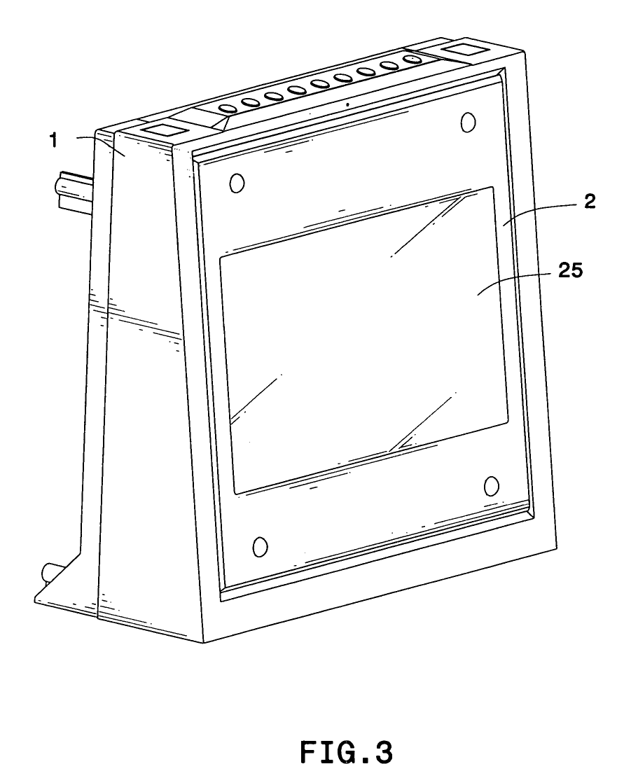

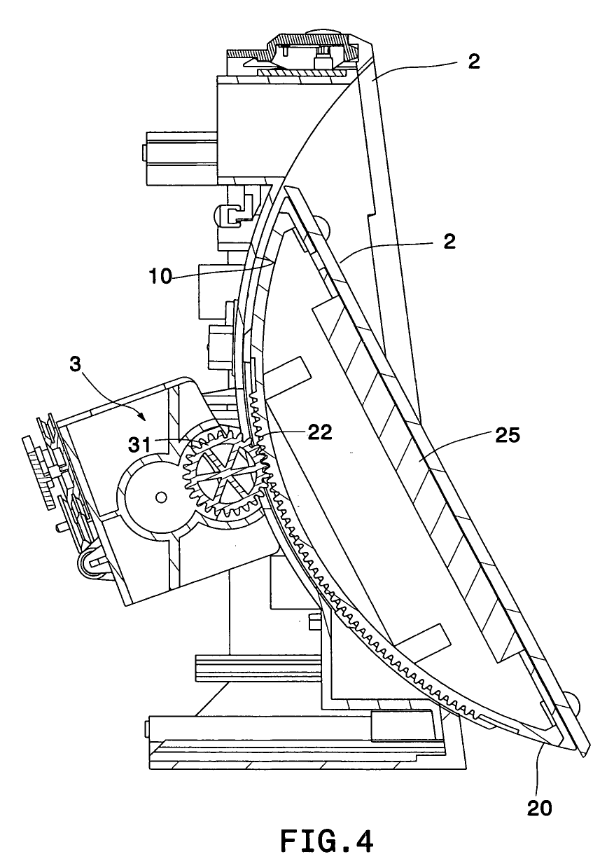

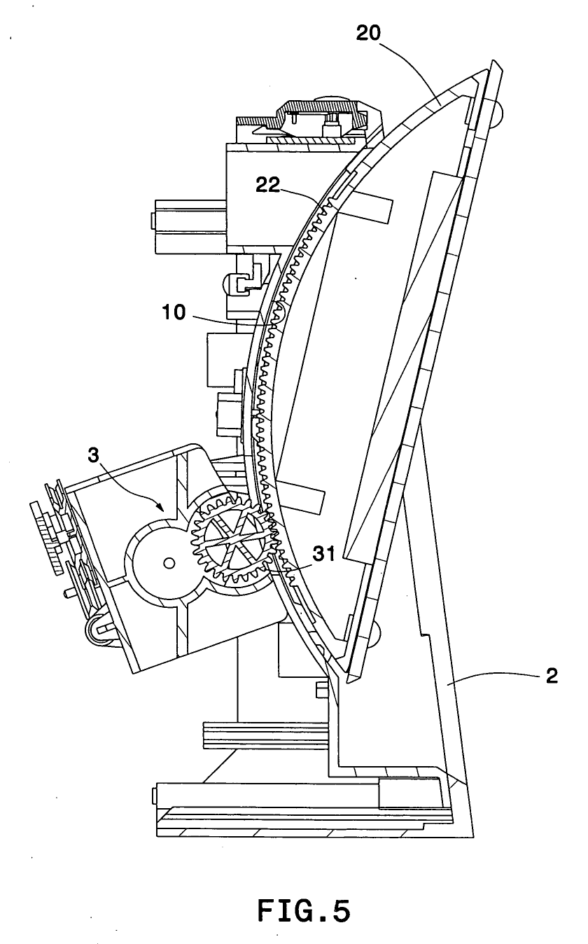

With reference to FIG. 3, it is noted that when the plate (2) is not pivoted and still relative to the base (1), the slot ( 1) and slits (12) shown in FIG. 1 are concealed and protected by the plate (2). With reference to FIGS. 4 and 5, however, when the plate (2) is pivoted due to the rotation of the gear (31), the slot (11) or the slits (12) are exposed so that the user is able to have access to the electronic elements mounted in either the slot (11) or the slits (12). Further, a monitor (25) may be mounted on the plate (2).

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A mini computer frame comprising:
a base having therein a receiving space; and
a plate pivotally connected to the base and received in the receiving space.

2. The mini computer frame as claimed in claim 1, wherein the plate has a smooth planar face with a monitor mounted thereon.

3. The mini computer frame as claimed in claim 1, wherein a motor driven gear is mounted on a bottom face defining the receiving space and mated with a rack formed on a face of the plate and received in the receiving space.

4. The mini computer frame as claimed in claim 2, wherein a motor driven gear is mounted on a bottom face defining the receiving space and mated with a rack formed on a face of the plate and received in the receiving space.

5. The mini computer frame as claimed in claim 3, wherein the face is an arcuate surface to face the bottom face defining the receiving space.

6. The mini computer frame as claimed in claim 4, wherein the face is an arcuate surface to face the bottom face defining the receiving space.

7. The mini computer frame as claimed in claim 5, wherein the bottom face defining the receiving space has an opening corresponding to the gear to allow the gear to extend out of the opening and two sets of rollers rotatably mounted on the bottom face to correspond to and be received in two recessed tracks defined in the arcuate surface of the plate.

8. The mini computer frame as claimed in claim 6, wherein the bottom face defining the receiving space has an opening corresponding to the gear to allow the gear to extend out of the opening and two sets of rollers rotatably mounted on the bottom face to correspond to and be received in two recessed tracks defined in the arcuate surface of the plate.

9. The mini computer frame as claimed in claim 7, wherein two positioning rods are respectively mounted on two opposed side faces of the receiving space to correspond to and be received in two positioning recesses respectively defined in two opposed side faces of the plate.

10. The mini computer frame as claimed in claim 8, wherein two positioning rods are respectively mounted on two opposed side faces of the receiving space to correspond to and be received in two positioning recesses respectively defined in two opposed side faces of the plate.

11. The mini computer frame as claimed in claim 9, wherein a slot and slits are defined in the bottom face defining the receiving space.
